(19) United States
(12) Patent Application Publication
(10) Pub. No.: US 2024/0286519 A1
(43) Pub. Date: Aug. 29, 2024

(54) VEHICLE CHARGING AND DISCHARGING METHOD FOR ELECTRICITY TRADING AND V2G SYSTEM USING SAME

(71) Applicants: Hyundai Motor Company, Seoul (KR); Kia Corporation, Seoul (KR)

(72) Inventors: Tae Hyun LEE, Yongin-si (KR); Sung Bae JEON, Hwaseong-si (KR); Dae Young KIM, Hwaseong-si (KR); Hui Un SON, Suwon-si (KR); Gyu Ri LEE, Namyangju-si (KR)

(73) Assignees: Hyundai Motor Company, Seoul (KR); Kia Corporation, Seoul (KR)

(21) Appl. No.: 18/369,318

(22) Filed: Sep. 18, 2023

(30) Foreign Application Priority Data
Feb. 27, 2023 (KR) 10-2023-0025947

(51) Int. Cl. B60L 53/66; B60L 53/51; B60L 53/62; B60L 53/63; B60L 53/64; B60L 55/00

(52) U.S. Cl. CPC B60L 53/665; B60L 53/51; B60L 53/62; B60L 53/63; B60L 53/64; B60L 55/00; B60L 2240/72; B60L 2260/44; B60L 2260/54

(57) ABSTRACT

A method of controlling vehicle charging and discharging for electricity trading and a V2G system using the same includes obtaining information for selling electricity, the information including an electricity unit cost by time, determining whether to sell electricity of a vehicle and an amount of electricity available to be sold based on the information for selling the electricity of the vehicle, and transmitting the electricity from the vehicle to a grid based on a result of whether to sell the electricity of the vehicle and the amount of the electricity available to be sold.

### CROSS REFERENCE TO RELATED APPLICATIONS

The present application claims priority to Korean Patent Application No. 10-2023-0025947, filed Feb. 27, 2023, the entire contents of which is incorporated herein for all purposes by this reference.

### BACKGROUND OF THE PRESENT DISCLOSURE

### Field of the Present Disclosure

The present disclosure relates to a charging and discharging method for electricity trading and a Vehicle-to-Grid (V2G) system using the same, and more particularly, to a technique that determines whether to proceed with sales by supplying electricity charged in an eco-friendly vehicle to the outside and optimizes the amount of electricity to be sold.

### Description of Related Art

Vehicle-to-Grid (V2G) is a technology that connects a rechargeable eco-friendly vehicle to the grid to use the remaining electricity of a battery, and thus the eco-friendly vehicle is charged through the grid and the remaining electricity after driving is transmitted (discharged) back to the grid, so that the electric vehicle is used as a moving Energy Storage System (ESS). Accordingly, various derivative industries may arise so that a user buys electricity when an electricity price is cheap to charge the battery, and conversely sells electricity when the electricity price is expensive.

In this regard, generally disclosed is a method of buying and selling electricity and enabling a user to get maximum profits based on a charging and discharging server and data.

Furthermore, generally further disclosed is a method of determining the amount of electricity to be sold in consideration of an expected mileage and determining whether to sell electricity by user confirmation to buy the electricity when it is cheap and sell the electricity when it is expensive by use of an electric vehicle battery as an ESS.

Because such conventional technologies are based on a simple principle of buying electricity when it is cheap and selling the electricity when it is expensive, the conventional technologies do not consider the environment of a vehicle and do not propose a detailed vehicle control method.

Furthermore, because a driver's driving conditions are not considered, problems may occur when the conventional technologies are actually used or are applied to the vehicle.

Furthermore, in a case of generating electricity by use of a solar panel provided on a vehicle, capacity and a charging unit cost of the electricity generated using the solar panel are not taken into account.

Therefore, in the present field of the present disclosure, there is a demand for V2G technology that considers the detailed conditions of the vehicle and the driver and also considers the capacity and the charging unit cost of the electricity generated using the solar panel provided on the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing the Vehicle-to-Grid (V2G) technology considering detailed conditions of a vehicle and a driver.

Another objective of the present disclosure for solving the technical problems is to provide the V2G technology considering capacity and a charging unit cost of electricity generated using a solar panel provided on a vehicle.

A yet another objective of the present disclosure for solving the technical problems is to provide the V2G technology for electricity trading capable of accurately calculating profits.

According to exemplary embodiments of the present disclosure for realizing the above objectives for solving the technical problems, there is provided a method of controlling vehicle charging and discharging for electricity trading, the method including: obtaining information for selling electricity, the information including an electricity unit cost by time: determining whether to sell electricity of a vehicle and an amount of electricity available to be sold based on the information for selling the electricity of the vehicle; and transmitting the electricity from the vehicle to a grid based on a result of whether to sell the electricity of the vehicle and the amount of the electricity available to be sold.

In the instant case, the determining of whether to sell the electricity of the vehicle and the amount of the electricity available to be sold may further include determining whether to sell the electricity based on vehicle environment parameters, and the vehicle environment parameters may include vehicle state information and vehicle surrounding environment information.

In the instant case, the vehicle state information may include battery efficiency of the vehicle, battery state information, engine state information, and motor state information.

In the instant case, the vehicle surrounding environment information may include weather information.

In the instant case, the determining of whether to sell the electricity of the vehicle and the amount of the electricity available to be sold may further include determining whether to sell the electricity based on driving condition parameters, and the driving condition parameters may include at least one or more of an expected electricity usage amount for a day, a minimum required electricity amount, a required electricity amount margin, a weather-dependent battery usage margin, or a combination thereof in the vehicle.

In the instant case, the determining of whether to sell the electricity of the vehicle and the amount of the electricity available to be sold may further include determining whether to sell the electricity based on sales feasibility parameters, and the sales feasibility parameters may include at least one or more of battery discharging efficiency, battery charging efficiency, discharging efficiency by solar power generation, or a combination thereof.

In the instant case, in the determining of whether to sell the electricity of the vehicle and the amount of the electricity available to be sold, a profit when selling the electricity may be calculated based on the sales feasibility parameters, and based on a result of determining the profit, is whether to sell the electricity may be determined, and the profit when selling the electricity may be determined based on at least one or more of the battery discharging efficiency, the battery charging efficiency, solar power generation efficiency, the amount of the electricity available to be sold, or a combination thereof.

In the instant case, the amount of the electricity available to be sold may be determined based on an amount of electricity charged in a battery of the vehicle, an expected electricity usage amount for a day, a minimum required electricity amount, a required electricity amount margin, and a weather-dependent battery usage margin.

In the instant case, in the determining of whether to sell the electricity of the vehicle and the amount of the electricity available to be sold, the electricity of the vehicle may be determined to be sold only when a condition in which a value obtained by subtracting the charging efficiency from a sum of the discharging efficiency and the solar power generation efficiency is greater than or equal to a preset threshold value is satisfied.

In the instant case, the weather information may be received from a weather information server.

Meanwhile, according to the exemplary embodiments of the present disclosure, there is provided a Vehicle-to-Grid (V2G) system including: a vehicle for obtaining and transmitting vehicle state information to a server and transmitting electricity to a grid; and the server for determining whether to sell the electricity of the vehicle and an amount of the electricity available to be sold based on the vehicle state information and additional information for selling the electricity, the additional information including an electricity unit cost by time, wherein the vehicle may transmit the electricity to the grid based on whether to sell the electricity and the amount of the electricity available to be sold.

In the instant case, the server may be configured to determine whether to sell the electricity based on vehicle environment parameters, and the vehicle environment parameters may include the vehicle state information and vehicle surrounding environment information.

In the instant case, the vehicle state information may include battery efficiency of the vehicle, battery state information, engine state information, and motor state information.

In the instant case, the vehicle surrounding environment information may include weather information.

In the instant case, the server may be configured to determine whether to sell the electricity based on driving condition parameters, and the driving condition parameters may include at least one or more of an expected electricity usage amount for a day, a minimum required electricity amount, a required electricity amount margin, a weather-dependent battery usage margin, or a combination thereof in the vehicle.

In the instant case, the server may be configured to determine whether to sell the electricity based on sales feasibility parameters, and the sales feasibility parameters may include at least one or more of battery discharging efficiency, battery charging efficiency, discharging efficiency by solar power generation, or a combination thereof.

In the instant case, the server may be configured to determine a profit when selling the electricity based on the sales feasibility parameters, and based on a result of determining the profit, is configured to determine whether to sell the electricity, and the profit when selling the electricity may be determined based on at least one or more of the battery discharging efficiency, the battery charging efficiency, solar power generation efficiency, the amount of the electricity available to be sold, or a combination thereof.

In the instant case, the amount of the electricity available to be sold may be determined based on an amount of electricity charged in a battery of the vehicle, an expected electricity usage amount for a day, a minimum required electricity amount, a required electricity amount margin, and a weather-dependent battery usage margin.

In the instant case, the server may be configured to determine to sell the electricity of the vehicle only when a condition in which a value obtained by subtracting the charging efficiency from a sum of the discharging efficiency and the solar power generation efficiency is greater than or equal to a preset threshold value is satisfied.

In the instant case, the weather information may be received from a weather information server.

According to an exemplary embodiment of the present disclosure, accurate profit determination is enabled by way of determining the capacity and the charging unit cost of the electricity generated by use of the solar panel provided on the vehicle.

Furthermore, instead of charging the battery of the vehicle with the electricity generated using the solar panel provided on the vehicle, direct connection to the grid is established to provide the electricity, whereby profits may be maximized while minimizing electricity loss.

The effects of the present disclosure are not limited to the above-mentioned effects, and other effects that are not mentioned herein will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a conceptual view exemplarily illustrating an electricity transmission method of a Vehicle-to-Grid (V2G) system according to an exemplary embodiment of the present disclosure.

FIG. 2 is a view exemplarily illustrating the V2G system according to an exemplary embodiment of the present disclosure.

FIG. 3 is a view exemplarily illustrating an amount of electricity used by a vehicle according to external temperatures in summer.

FIG. 4 is a view exemplarily illustrating an example of a method of determining whether to sell electricity by a processor according to the exemplary embodiment of the present disclosure.

FIG. 5 is a view exemplarily illustrating another example of a method of determining whether to sell electricity by a processor according the exemplary embodiment of the present disclosure.

FIG. 6 is a view exemplarily illustrating a method of controlling vehicle charging and discharging in the V2G system according to the exemplary embodiment of the present disclosure.

FIG. 7 is a view exemplarily illustrating a method of controlling vehicle charging and discharging in the V2G system according to another exemplary embodiment of the present disclosure.

FIG. 8 is a conceptual view exemplarily illustrating a method of determining whether to sell electricity and an amount of electricity available to be sold in the V2G system according to the exemplary embodiment of the present disclosure.

FIG. 9A, FIG. 9B, FIG. 9C, FIG. 9D, FIG. 9E, FIG. 9F, FIG. 9G, FIG. 9H, and FIG. 9I are views exemplarily illustrating respective interface screens provided by a user terminal according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below: While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an exemplary embodiment included in the present specification will be described in detail with reference to the accompanying drawings, but regardless of the reference numerals, the same reference numerals are provided to identical or similar elements, and the overlapping description thereof will be omitted. The words “module” and “part/unit” used as noun suffixes for the components used in the following descriptions are provided or mixed in consideration of only the ease of writing the specification, and the words do not have distinct meanings or roles by themselves. In describing the exemplary embodiment included in the present specification, when it is determined that a detailed description of a related known technology may obscure the subject matter of the exemplary embodiment included in the present specification, the detailed description thereof will be omitted. Furthermore, the accompanying drawings are only for easy understanding of the exemplary embodiment included in the present specification, the technical idea included in the present specification is not limited by the accompanying drawings, and it should be understood that the accompanying drawings include all changes, equivalents, or substitutes, which are included in the spirit and technical scope of the present disclosure.

It will be understood that, although the terms including ordinal numbers, such as first, second, etc. may be used herein to describe various elements, these elements should not be limited by these terms. These terms are only used for distinguishing one component from another component.

It will be understood that when a component is referred to as being “coupled” or “connected” to another component, it may be directly coupled or connected to the other component or intervening components may be present. In contrast, when a component is referred to as being “directly connected”, “directly coupled”, or “directly linked” to another component, it should be understood that there are no intervening component present therebetween.

As used herein, the singular forms are intended to include the plural forms as well, unless the context clearly indicates otherwise.

It will be further understood that the terms “comprise”, “include”, “have”, etc. When used in the present specification, specify the presence of stated features, integers, steps, operations, elements, components, and/or combinations thereof but do not preclude the presence or addition of one or more other features, integers, steps, operations, elements, components, and/or combinations thereof.

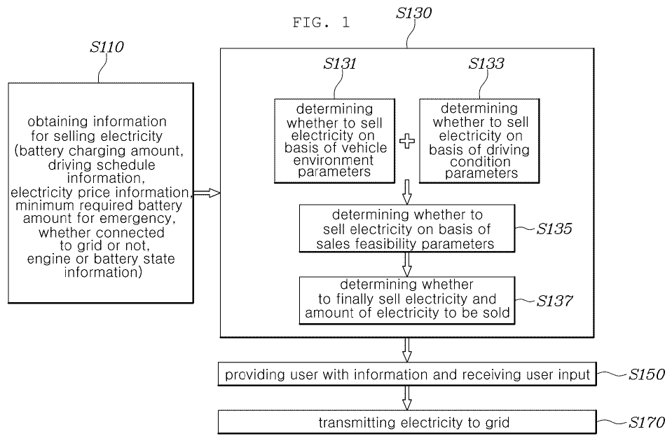

FIG. 1 is a conceptual view exemplarily illustrating an electricity transmission method of the Vehicle-to-Grid (V2G) system according to the exemplary embodiment of the present disclosure.

Referring to FIG. 1, in step S110, a V2G system obtains information for selling electricity.

In the instant case, the information for selling electricity may include at least one or more of a battery charging amount, driving schedule information, electricity price information, a minimum required battery amount for an emergency, whether connected to the grid or not, engine or battery state information, or a combination thereof.

Next, in step S130, the V2G system is configured to determine whether to sell electricity and the amount of electricity to be transmitted based on the information for selling electricity.

The V2G system is configured to determine whether to sell electricity based on the vehicle environment parameters in step S131, is configured to determine whether to sell the electricity based on the driving condition parameters in step S133, is configured to determine whether to sell the electricity based on the sales feasibility parameters in step S135, and is configured to determine whether to finally sell the electricity and the amount of the electricity to be sold in step S137.

In the instant case, the vehicle environment parameters may include: vehicle state information such as vehicle battery state information and engine state information; and vehicle surrounding environment information such as weather.

In the instant case, when there is a problem with a battery or an engine, electricity transmission of the vehicle may be set unavailable.

In the instant case, because a battery usage amount of the vehicle varies depending on weather, the V2G server may use weather data to determine the battery usage amount required for the vehicle based on efficiency γ according to the weather, and determine the amount of electricity to be transmitted within the remaining amount of electricity excluding the determined battery usage amount.

In the instant case, battery charging and discharging efficiency may vary depending on a use period of the battery, and in a case of a vehicle having an old battery, electricity transmission of the vehicle may be set unavailable to ensure stability.

In the instant case, the driving condition parameters may include a minimum required electricity amount for driving.

In the instant case, the V2G system may be configured to determine the amount of electricity to be transmitted within the remaining amount of electricity excluding the minimum required electricity amount δ required in an emergency in consideration of a situation in which a vehicle should be suddenly operated at the time of the electricity transmission.

In the instant case, the V2G system may set a minimum margin constant ε in consideration of a situation in which the vehicle should be operated for greater than or equal to a planned mileage or planned driving time, and based on the set minimum margin constant ¿, is may be configured to determine an amount of electricity available for electricity transmission.

Meanwhile, the sales feasibility parameters may include battery discharging efficiency α, battery charging efficiency, and discharging efficiency (by solar power generation.

In the instant case, when a vehicle continues to drive along an existing route such as a commuting route, an amount of electricity used per day and an amount of electricity used for the same route thereafter may be estimated through route learning.

In the instant case, the V2G system may be configured to predict electricity demand, and compare an expected profit when selling electricity today with an expected profit when selling electricity tomorrow, so as provide a user with a comparison result.

In the instant case, when the expected profit is less than or equal to a predetermined amount, electricity trading, that is, electricity transmission may not be performed in consideration of a battery service life.

Meanwhile, when a solar panel is provided on a vehicle to perform solar power generation, the sales feasibility parameters may be determined based on an amount of electricity charged by the solar power generation.

In the instant case, the amount of electricity charged by the solar power generation may be defined as the discharging efficiency (by solar power generation.

In the instant case, because sunlight is greatly affected by weather, settings may be made to directly transmit electricity to the grid without going through a battery when the battery of a vehicle is charged greater than or equal to a predetermined reference value of State of Charge (SOC).

Meanwhile, in step S150, the V2G system provides a user with information on whether to transmit electricity and the amount of electricity to be transmitted, and receives a user input on whether to transmit electricity or not.

In the instant case, the providing of the user with the information on whether to transmit electricity and the amount of electricity to be transmitted and the receiving of the user input on whether to transmit electricity may be performed by a user terminal.

Meanwhile, in step S170, when an acceptance for performing electricity transmission is received from the user, the V2G system transmits electricity to the grid.

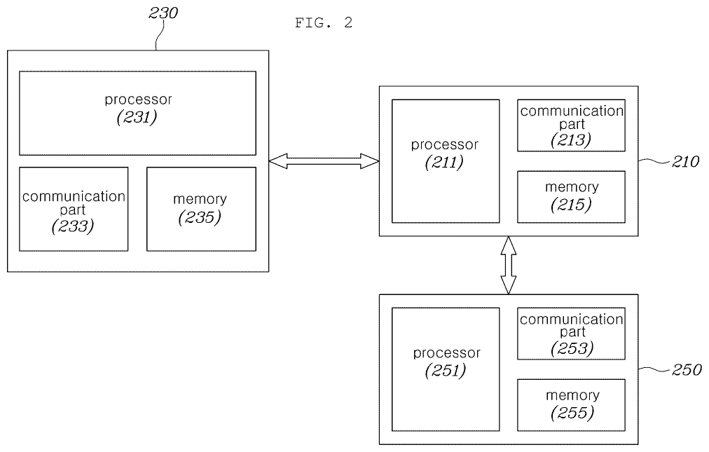

FIG. 2 is a view exemplarily illustrating the V2G system according to the exemplary embodiment of the present disclosure.

Referring to FIG. 2, the V2G system 200 includes a server 210, a vehicle 230, and a user terminal 250.

The server 210 includes a processor 211, a communication portion 213, and a memory 215. In the instant case, the server 210 may be provided integrally with a vehicle 230. For example, when the vehicle 230 is a hybrid electric vehicle, the server 210 may be a Hybrid Control Unit (HCU) of the vehicle 230.

The processor 211 is configured to determine whether to sell electricity and the amount of electricity to be sold based on information for selling electricity.

The communication portion 213 receives the information for selling electricity from the vehicle 230, the terminal 250, or an external server, transmits the information on whether to sell electricity and the amount of electricity to be sold to the user terminal 250, receives a user input on whether to perform selling electricity from the user terminal 250, and transmits the user input to the vehicle 230.

In the instant case, the information on whether to sell electricity and the amount of electricity to be sold may be determined based on the sales feasibility parameters, vehicle environment parameters, and driving condition parameters.

In the instant case, the sales feasibility parameters may include at least one or more of the battery discharging efficiency α, the battery charging efficiency β, the discharging efficiency by solar power generation ξ, or the combination thereof.

In the instant case, the processor 211 may be configured to determine a profit when selling electricity based on the sales feasibility parameters, and based on a result of determining the profit, may be configured to determine whether to sell the electricity.

In the instant case, the profit when selling the electricity, that is, a final selling price of the electricity may be determined based on Equation 1 below:

$$y = ( α - β ) * electricity amount available to be sold \qquad [ Equation 1 ]$$

where, in Equation 1 above, y denotes final selling price, a denotes battery discharging efficiency, and β denotes battery charging efficiency. In the instant case, when electricity charged in a vehicle is sold to the grid, the discharging efficiency is determined based on electricity efficiency and an electricity selling price when the electricity charged in the battery of the vehicle is discharged to the grid. In the instant case, when the electricity of the vehicle is charged, the charging efficiency is determined based on electricity efficiency and electric charging cost when electricity is charged to the battery of the vehicle.

That is, when electricity is recharged at home after the electricity is sold to the grid, the electricity is determined not to be sold in a case where a difference between a profit obtained from selling the electricity and a cost of recharging the electricity at home is not large or in a case where the recharging of the electricity at home costs more.

In the instant case, the discharging efficiency and the charging efficiency may be determined based on weather and electricity sales data according to time in the last few days previously set.

For example, settings may be made to sell electricity only when a condition in which a value obtained by subtracting the charging efficiency from the discharging efficiency is greater than or equal to a preset certain value is satisfied.

In the instant case, when a vehicle repeatedly travels along a predetermined driving route, a more accurate electricity usage amount may be determined through learning and the like, and based on a result of the learning, may be configured to determine an amount of electricity available to be sold.

Meanwhile, the profit when selling electricity, that is, the final selling price of electricity may be determined based on Equation 2 below as well.

$$y = ( ( α + ζ ) - β ) * amount of electricity available to be sold \qquad [ Equation 2 ]$$

where, in Equation 2 above, y denotes final selling price, α denotes battery discharging efficiency, ξ denotes solar power generation efficiency, and β denotes battery charging efficiency. In the instant case, the solar power generation efficiency is determined based on the electricity efficiency and the electricity selling price at a time when electricity obtained from solar power generation is sold.

For example, settings may be made so that electricity is sold only when a condition in which a value obtained by subtracting the battery discharging efficiency from a sum of the battery discharging efficiency and the solar power generation efficiency is greater than or equal to a preset threshold value is satisfied.

In the instant case, when a vehicle repeatedly travels along a predetermined driving route, a more accurate electricity usage amount may be determined through learning and the like, and based on a result of the learning, may be configured to determine the amount of electricity available to be sold.

In the instant case, the server 210 may check a charging price and selling price of electricity until a charging time obtained by learning based on big data considering weather and situations, and may compare a profit when selling electricity charged in a vehicle now with a profit when selling electricity at another time in the future, providing a user with a comparison result.

For example, when an electricity selling price is predetermined according to a specific time period or a seasonal characteristic such as summer or winter, information related to this may be provided to the user. For example, in a case where a time point when an electricity rate is most expensive during a day is 2:00 PM, information related to a profit which is the highest when selling electricity at 2:00 PM may be provided to the user. Furthermore, when an electricity selling price is expected to rise according to a weather forecast so that a record-breaking heat wave will occur tomorrow, information related to the present forecast may be provided to the user.

Furthermore, as a specific broadcasting program event occurs, in a case where a large amount of profit is generated when selling electricity, information related to the present event may be provided to the user. For example, when an electricity selling price is high due to an occurrence of a predetermined sporting event including a high viewer rating thereof at 8:00 PM, information related to this may be provided to the user.

In the instant case, weather forecast information may be received from a weather information server.

In the instant case, information on the specific broadcasting program event may be received from a broadcasting information server.

Meanwhile, the vehicle environment parameters may include a battery usage margin γ according to weather.

In the instant case, the communication portion 213 may receive current battery charging information from the vehicle 230 and may receive real-time weather data or weather data for a day from a weather server.

Furthermore, the processor 211 may be configured to determine an expected electricity usage amount based on data of a battery usage margin expected according to weather.

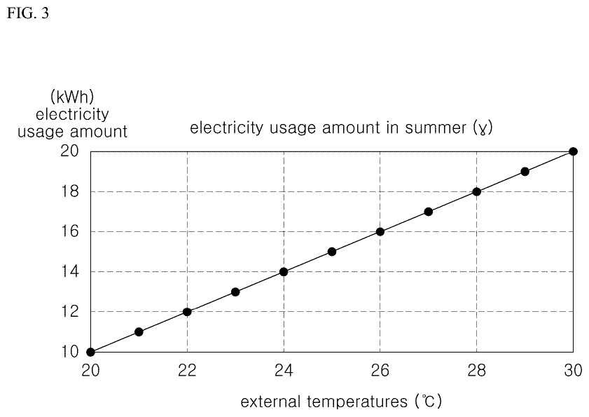

For example, the data of the expected battery usage margin based on the weather may be set so that an expected battery usage amount based on the weather increases in summer. Referring to FIG. 3, for example, an amount of electricity used may be 10 kwh when an external temperature is 20° C., an amount of electricity used may be 12 kwh when an external temperature is 22° C., an amount of electricity used may be 14 kwh when an external temperature is 24° C., an amount of electricity used may be 16 kwh when an external temperature is 26° C., an amount of electricity used may be 18 kwh when an external temperature is 28° C., and an amount of electricity used may be 20 kwh when an external temperature is 30° C.

Meanwhile, the driving condition parameters may include at least one or more of an expected electricity usage amount for a day, a minimum required electricity amount, a required electric amount margin, a weather-dependent battery usage margin, or a combination thereof.

In the instant case, the processor 211 may be configured to determine the expected electricity usage amount for a day based on information related to an expected mileage of the vehicle 230 for a day.

Furthermore, the driving condition parameters may further include a minimum required electricity amount δ which may be used in an emergency.

In the instant case, the processor 211 may be configured to determine whether to sell electricity based on a result of comparison between an amount of electricity charged in a battery and a minimum required electricity amount δ in consideration of a situation in which driving is required in the emergency.

In the instant case, when the amount of electricity charged in the battery is less than the minimum required electricity amount δ, the electricity may be set not to be sold.

In the instant case, the amount of electricity available to be sold may be determined based on a larger value between the estimated electricity usage amount for a day and the minimum required electricity amount δ.

In the instant case, the amount of electricity available to be sold may be determined based on adding a required electricity amount margin ε according to an additional mileage to a minimum electricity usage amount.

In the instant case, the amount of electricity available to be sold may be determined based on Equation 3 below.

amount of electricity available to be sold=amount of electricity charged in battery−max(expected electricity usage amount for day,δ)+ε+γ [Equation 3]

where, in Equation 3 above, δ denotes minimum required electricity amount, ε denotes required electricity amount margin, and γ denotes weather-dependent battery usage margin.

Meanwhile, the processor 211 may be configured to determine whether to sell electricity based on a following method of determining whether to sell electricity.

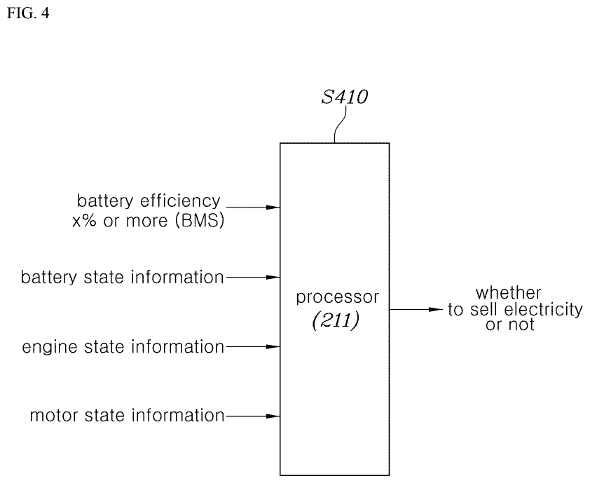

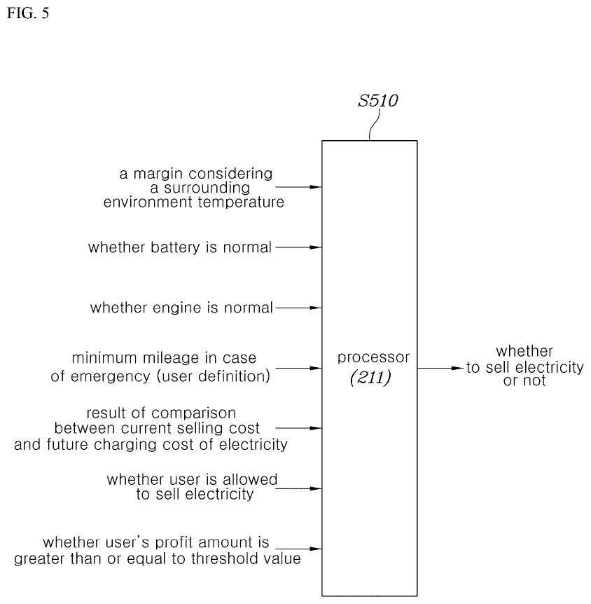

FIG. 4 is a view exemplarily illustrating an example of the method of determining whether to sell electricity by the processor 211 of the server 210 according to the exemplary embodiment of the present disclosure.

Referring to FIG. 4, in step S410, the processor 211 is configured to determine whether to sell electricity based on battery efficiency, battery state information, engine state information, and motor state information of a vehicle 230.

In the instant case, the battery efficiency, battery state information, engine state information, and motor state information may be received from the vehicle 230.

For example, when the battery efficiency of the vehicle 230 is x % or less, electricity sales may be set unavailable to ensure stability of the vehicle 230. In the instant case, a threshold value x for the battery efficiency may be determined according to the type of vehicle 230, the season, and the capacity of the battery. Furthermore, the battery efficiency of the vehicle 230 may be received from a battery management system (BMS) of the vehicle 230.

In the instant case, according to a safety logic, when a problem with the battery, engine, or motor of the vehicle 230 is found, electricity sales may be set unavailable.

For example, when a temperature of the battery is greater than or equal to a critical temperature or when a part of the battery is out of order, electricity sales may be set unavailable.

Furthermore, in a case of a hybrid vehicle, when malfunctioning of the engine occurs more than once a day, electricity sales may be set unavailable.

Furthermore, when malfunctioning of the motor occurs, electricity sales may be set unavailable because more electricity than the required electricity of the vehicle 230 may be consumed.

FIG. 5 is a view exemplarily illustrating another example of a method of determining whether to sell electricity by the processor 211 of the server 210 according the exemplary embodiment of the present disclosure.

Referring to FIG. 5, in step S510, the processor 211 is configured to determine whether to sell electricity based on a margin considering a surrounding environment temperature, whether the battery is normal, whether the engine is normal, a minimum mileage in case of an emergency, a result of comparison between a current selling cost and a future charging cost of the electricity, whether a user is allowed to sell electricity, and whether the user's profit amount is greater than or equal to a threshold value.

Referring back to FIG. 2, the memory 215 stores information for determining whether or not to sell electricity or the amount of electricity to be sold.

For example, the memory 215 may store at least one or more of the margin considering the surrounding environment temperature, whether the battery is normal, whether the engine is normal, the minimum mileage in case of the emergency, the current selling cost of electricity, the future charging cost of electricity, whether the user is allowed to sell electricity, the user profit amount, the threshold value of the user profit amount, and a combination thereof.

Referring back to FIG. 2, the vehicle 230 includes a processor 231, a communication portion 233, and a memory 235.

The processor 231 checks whether the vehicle 230 is connected to the grid through an electricity transmission/reception cable, obtains information for electricity transmission, and is configured to perform the electricity transmission to the grid.

In the instant case, the information for electricity transmission may include the amount of electricity charged in the battery, battery efficiency, whether the battery is normal, whether the engine is normal, and whether the motor is normal.

The communication portion 233 transmits the information for electricity transmission to the server 210 and receives a request for performing electricity transmission from the server 210.

The memory 235 stores the information for electricity transmission.

The user terminal 250 includes a processor 251, a communication portion 253, and a memory 255.

The user terminal 250 may be applied to various terminals such as a smart phone, a portable terminal, a mobile terminal, a foldable terminal, a Personal Digital Assistant (PDA), a Portable Multimedia Player (PMP) terminal, a telematics terminal, a navigation terminal, a personal computer, a notebook computer, a slate PC, a tablet PC, a ultrabook, a wearable device (e.g., including a watch-type terminal (a smartwatch), a glass-type terminal (a smart glass), a Head Mounted Display (HMD), etc.), a WiBro terminal, an Internet Protocol Television (IPTV) terminal, a smart TV, a digital broadcasting terminal, an Audio Video Navigation (AVN) terminal, an Audio/Video (A/V) system, a flexible terminal, and a digital signage device. In the instant case, transmission and reception of information between the server 210 and the user terminal 250 may be performed through an app or an internet browser, which is provided on the user terminal 250.

The processor 251 provides the information received from the server 210 to a user, and generates and provides an interface for receiving, from the user, an input on whether to perform electricity transmission.

In the instant case, through the user interface, the processor 251 may provide the user with information on a time when a selling price of electricity based on a day is expected to be the most expensive and with background data for the present information.

Furthermore, through the user interface, the processor 251 may receive information on an additional driving route from the user, and the communication portion 253 may transmit the information on the additional driving route, received by a user input, to the server 210.

In the instant case, based on the present information, the server 210 may redetermine the amount of electricity available to be sold and the final selling price.

Meanwhile, the processor 251 may guide a route to a location, in which electricity is able to be sold, within a critical distance based on current location information of the vehicle 230 when electricity is expected to be sold for a day, and provide a notification to the user when the vehicle 230 arrives at the location where the electricity is able to be sold.

For example, the processor 251 may guide a route leading to a parking lot provided with a facility enabling electricity to be sold.

Furthermore, the processor 251 may transmit, to the user, a notification of a dedicated plug connection for electricity transmission before the user gets off the vehicle 230.

In the instant case, the notification to the user may be provided through a pop-up on a display screen, or a voice or warning sound through a speaker.

Meanwhile, the processor 251 may provide the user with a unit purchase price of electricity and with capacity and a unit selling price of the electricity to be sold.

Furthermore, the processor 251 may provide the user with information related to an estimated traffic route of the vehicle 230 based on time after the sale of electricity and with information on the remaining battery capacity after the sale of electricity.

The communication portion 253 receives, from the server 210, information on whether to perform electricity transmission and the amount of electricity to be transmitted, and transmits, to the server 210, user input information on whether to perform the electricity transmission.

The memory 255 stores information on whether to perform electricity transmission and the amount of electricity to be transmitted.

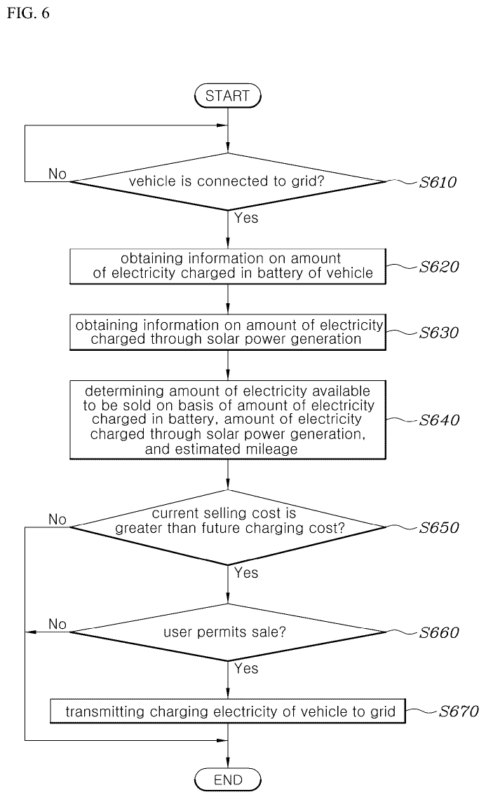

FIG. 6 is a view exemplarily illustrating a method of controlling vehicle charging and discharging in the V2G system according to the exemplary embodiment of the present disclosure.

Referring to FIG. 6, a vehicle 230 is configured to determine whether being connected to the grid or not in step S610, and when connected to the grid, the vehicle 230 obtains information on an amount of electricity charged in a battery of the vehicle 230 in step S620.

In the instant case, the vehicle 230 may be connected to the grid through a charging and discharging cable.

Furthermore, in step S630, the V2G system obtains information on an amount of electricity charged through solar power generation of the vehicle 230.

Furthermore, in step S640, the V2G system is configured to determine the amount of electricity available to be sold based on the amount of electricity charged in the battery, the amount of electricity charged through the solar power generation, and an estimated mileage.

Furthermore, the V2G system is configured to determine whether a current selling cost of electricity of the vehicle 230 is greater than a future charging cost in step S650, is configured to determine whether permission to sell electricity has been received from the user terminal 250 or not when the current selling cost of the electricity of the vehicle 230 is greater than the future charging cost in step S660, and transmits the charging electricity of the vehicle 230 to the grid when the permission to sell the electricity is received from the user in step S670.

In the instant case, in step S660, the user terminal 250 receives, from the server 210, information related to the amount of electricity to be sold, the remaining amount of electricity after selling the electricity, and the profit when selling the electricity, provides the information to the user through the user interface, and receive a user input on whether to sell the electricity, so that permission to sell the electricity may be received from the user.

In the exemplary embodiment of the present disclosure, operations of steps S610 and S670 may be performed by the vehicle 230, operations of steps S620 to S650 may be performed by the server 210, and operation of step S660 may be performed by the user terminal 660.

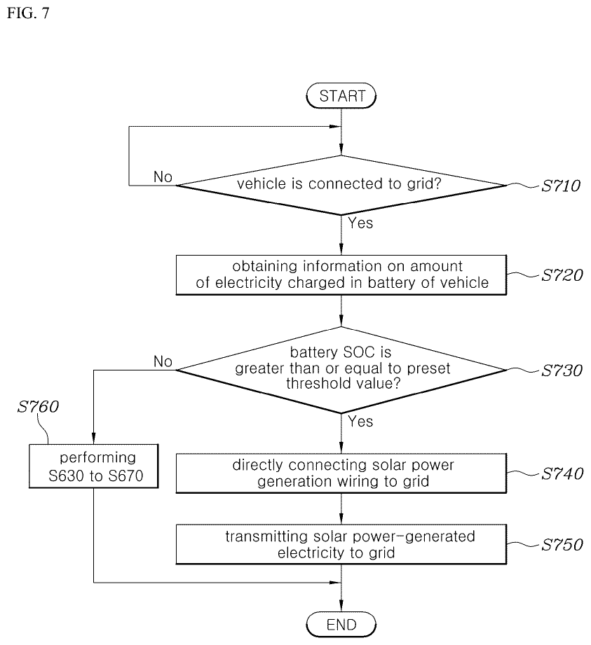

FIG. 7 is a view exemplarily illustrating a method of controlling vehicle charging and discharging in the V2G system according to another exemplary embodiment of the present disclosure.

Referring to FIG. 7, a vehicle 230 is configured to determine whether being connected to the grid or not in step S710, and when connected to the grid, the vehicle 230 obtains information on an amount of electricity charged in a battery of the vehicle 230 in step S720.

In the instant case, the vehicle 230 may be connected to the grid through a charging and discharging cable.

Furthermore, the V2G system is configured to determine whether a State of charge (SOC) value of the battery of the vehicle 230 is greater than or equal to a preset threshold value or not in step S730, and when the State of charge (SOC) value of the battery of the vehicle 230 is greater than or equal to the preset threshold value, the V2G system directly connects solar power generation wiring to the grid in step S740 and transmits solar power-generated electricity to the grid in step S750.

Meanwhile, as a result of the determination in step S730, when the SOC value of the battery of the vehicle 230 is smaller than the preset threshold value, steps S630 to S670 are performed to transmit the charging electricity of the vehicle to the grid in step S760.

In the exemplary embodiment of the present disclosure, operations of steps S710, S740, and S750 may be performed by the vehicle 230, and operations of steps S720 and S730 may be performed by the server 210. Furthermore, step S760 may be performed by the server 210 or the vehicle 230 according to each operation thereof.

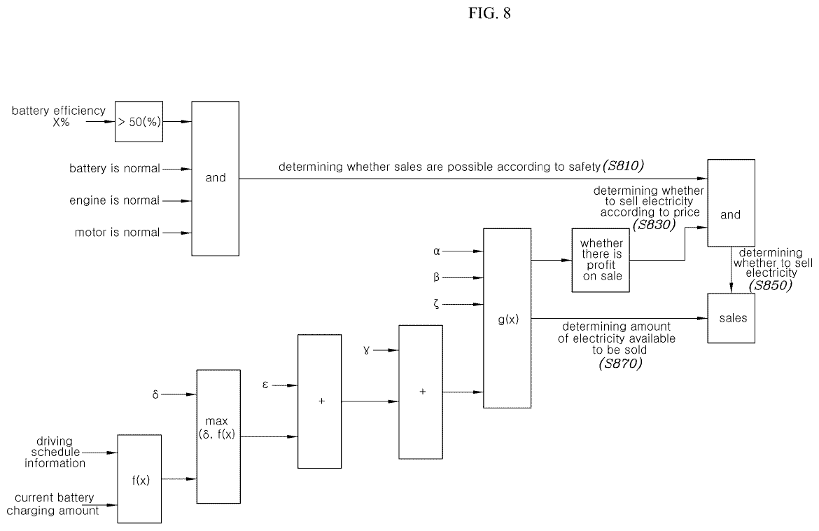

FIG. 8 is a conceptual view exemplarily illustrating a method of determining whether to sell electricity and an amount of electricity available to be sold in the V2G system according to the exemplary embodiment of the present disclosure. Each step of FIG. 8 may be performed by a server 210.

Referring to FIG. 8, in step S810, the server 210 is configured to determine whether electricity is available to be sold or not according to safety based on battery efficiency, whether a battery is normal, whether an engine is normal, and whether a motor is normal.

Furthermore, in step S830, the server 210 is configured to determine whether to sell electricity according to price based on the parameters of the vehicle 230 including driving schedule information, a current battery charging amount, a minimum required electricity amount δ, a required electricity amount margin ¿, a weather-dependent battery usage margin γ, discharging efficiency α, charging efficiency β, and solar power generation efficiency ξ.

In the instant case, based on the parameters of the vehicle 230 including the driving schedule information, the current battery charging amount, the minimum required electricity amount δ, the required electricity amount margin ε, the weather-dependent battery usage margin γ, the discharging efficiency α, the charging efficiency β, and the solar power generation efficiency ξ, the server 210 may be configured to determine whether there is a profit on sale or whether the profit on sale is greater than or equal to a preset threshold value, and based on a result of the determining, the server 210 may be configured to determine whether to sell the electricity.

Furthermore, in step S850, the server 210 is configured to determine whether to sell electricity based on the determination in step S810 on whether to sell electricity according to the safety and the determination in step S830 on whether to sell electricity according to price.

Furthermore, in step S870, the server 210 is configured to determine the amount of electricity available to be sold based on the parameters of the vehicle 230, including the driving schedule information, the current battery charging amount, the minimum required electricity amount δ, the required electricity amount margin ε, the weather-dependent battery usage margin γ, the discharging efficiency α, the charging efficiency β, and solar power generation efficiency ξ.

The result of determination on whether to sell the electricity determined in step S850 and the information on the amount of electricity available to be sold determined in step S870 are transmitted to the user terminal 250 and subjected to the user's final confirmation, so that whether to permit the sale of electricity may be received from the user terminal 250, and when the permission information on the sale of electricity is received from the user terminal 250, the present information may be transmitted to the vehicle 230, allowing the electricity to be transmitted to the grid.

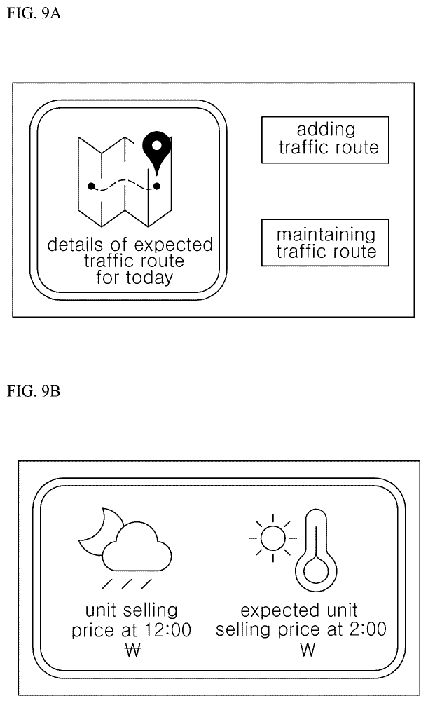

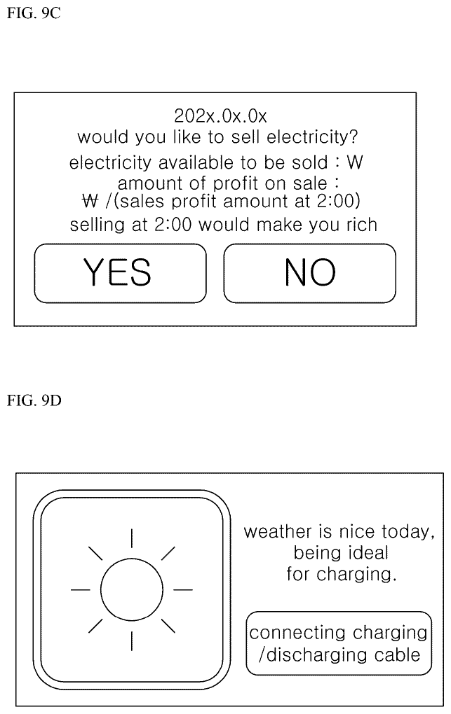

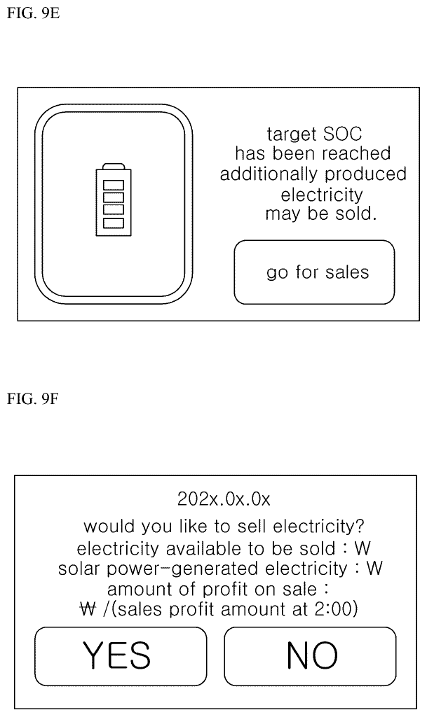

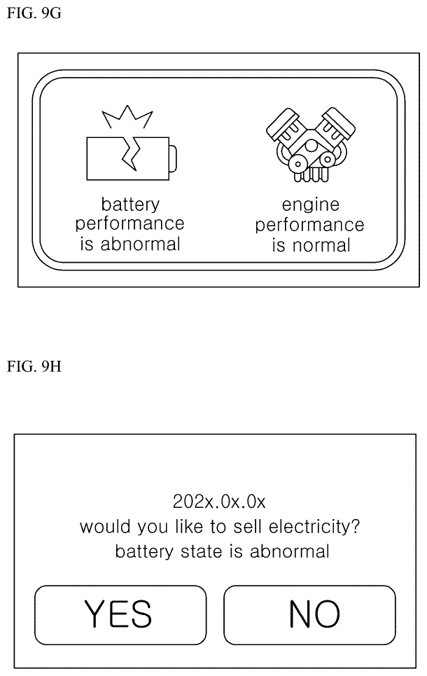

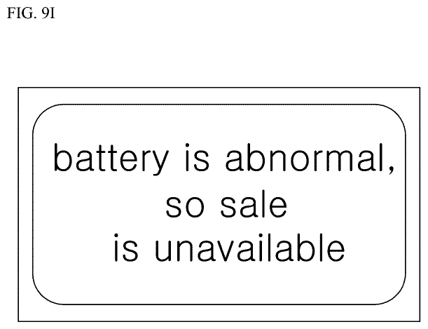

FIG. 9A, FIG. 9B, FIG. 9C, FIG. 9D, FIG. 9E, FIG. 9F, FIG. 9G, FIG. 9H, and FIG. 9I are views exemplarily illustrating interface screens provided by a user terminal according to the exemplary embodiment of the present disclosure.

Referring to FIG. 9A, the user terminal 250 may provide a user with information related to an expected traffic route for a day of a vehicle 230 and enable the user to add a new traffic route.

Furthermore, referring to FIG. 9B, the user terminal 250 may compare and provide information related to expected selling prices of electricity charged in the vehicle 230 according to time and weather to the user. For example, the user terminal 250 may compare and provide a unit selling price at 12:00 and a unit selling price at 2:00, and may provide a screen for confirming a final sale as shown in FIG. 9C when the user selects one of the compared and provided unit selling prices through a touch input on a screen.

Furthermore, referring to FIG. 9D, the user terminal 250 may provide the user with an interface screen for receiving an input on whether to perform solar power generation considering weather of a day.

Furthermore, referring to FIG. 9E, when a battery of the vehicle 230 reaches a target State of Charge (SOC), the user terminal 250 may provide an interface screen for receiving an input on whether to sell electricity generated by the solar power generation.

Furthermore, referring to FIG. 9F, when the user terminal 250 provides a screen for confirming the final sale of electricity of the vehicle 230, the user terminal 250 may provide information on the amount of electricity available to be sold including the electricity generated by the solar power generation and an expected profit when selling the electricity.

Furthermore, referring to FIG. 9G, the user terminal 250 may provide information on whether the battery of the vehicle 230 is normal and information on whether the engine is normal.

Furthermore, referring to FIG. 9H, when the user attempts to sell electricity in a state where the battery or engine of the vehicle 230 includes a problem, the user terminal 250 may provide a screen for confirming the final sale of electricity while including information related to the present attempt.

Furthermore, referring to FIG. 9I, according to a preset internal setting, the user terminal 250 may be set not to sell electricity when there is an abnormality in the battery or the like of the vehicle 230. In the instant case, when the user attempts to sell the electricity, a warning message indicating that the sale of the electricity is unavailable may be output.

According to the exemplary embodiment of the present disclosure described so far, the accurate profit determination is enabled by way of determining the capacity and the charging unit cost of the electricity generated by use of the solar panel provided on the vehicle.

Furthermore, instead of charging the battery of the vehicle with the electricity generated using the solar panel provided on the vehicle, direct connection to the grid is established to provide the electricity, whereby profits may be maximized while minimizing electricity loss.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling vehicle charging and discharging for electricity trading, the method comprising:
obtaining information for selling electricity, the information including an electricity unit cost by time;
determining whether to sell electricity of a vehicle and an amount of electricity available to be sold based on the information for selling the electricity of the vehicle; and
transmitting the electricity from the vehicle to a grid based on a result of whether to sell the electricity of the vehicle and the amount of the electricity available to be sold.

2. The method of claim 1,
wherein the determining of whether to sell the electricity of the vehicle and the amount of the electricity available to be sold further includes determining whether to sell the electricity based on vehicle environment parameters, and
wherein the vehicle environment parameters includes vehicle state information and vehicle surrounding environment information.

3. The method of claim 2, wherein the vehicle state information includes battery efficiency of the vehicle, battery state information, engine state information, and motor state information.

4. The method of claim 2, wherein the vehicle surrounding environment information includes weather information.

5. The method of claim 1,
wherein the determining of whether to sell the electricity of the vehicle and the amount of the electricity available to be sold further includes determining whether to sell the electricity based on driving condition parameters, and
wherein the driving condition parameters includes at least one of an expected electricity usage amount for a day, a minimum required electricity amount, a required electricity amount margin, a weather-dependent battery usage margin, or a combination thereof in the vehicle.

6. The method of claim 1,
wherein the determining of whether to sell the electricity of the vehicle and the amount of the electricity available to be sold further includes determining whether to sell the electricity based on sales feasibility parameters, and
wherein the sales feasibility parameters includes at least one of battery discharging efficiency, battery charging efficiency, discharging efficiency by solar power generation, or a combination thereof.

7. The method of claim 6, wherein, in the determining of whether to sell the electricity of the vehicle and the amount of the electricity available to be sold, a profit when selling the electricity is determined based on the sales feasibility parameters, and based on a result of determining the profit, whether to sell the electricity is determined, and
the profit when selling the electricity is determined based on at least one of the battery discharging efficiency, the battery charging efficiency, solar power generation efficiency, the amount of the electricity available to be sold, or a combination thereof.

8. The method of claim 7, wherein the amount of the electricity available to be sold is determined based on an amount of electricity charged in a battery of the vehicle, an expected electricity usage amount for a day, a minimum required electricity amount, a required electricity amount margin, and a weather-dependent battery usage margin.

9. The method of claim 7, wherein, in the determining of whether to sell the electricity of the vehicle and the amount of the electricity available to be sold, the electricity of the vehicle is determined to be sold only when a condition in which a value obtained by subtracting the battery charging efficiency from a sum of the battery discharging efficiency, and the solar power generation efficiency is greater than or equal to a preset threshold value is satisfied.

10. The method of claim 4, wherein the weather information is received from a weather information server.

11. A Vehicle-to-Grid (V2G) system comprising:
a vehicle for obtaining and transmitting vehicle state information to a server and transmitting electricity to a grid; and
the server for determining whether to sell the electricity of the vehicle and an amount of the electricity available to be sold based on the vehicle state information and additional information for selling the electricity, the additional information including an electricity unit cost by time,
wherein the vehicle is configured to transmit the electricity to the grid based on whether to sell the electricity and the amount of the electricity available to be sold.

12. The Vehicle-to-Grid system of claim 11,
wherein the server is configured to determine whether to sell the electricity based on vehicle environment parameters, and
wherein the vehicle environment parameters includes the vehicle state information and vehicle surrounding environment information.

13. The Vehicle-to-Grid system of claim 12, wherein the vehicle state information includes battery efficiency of the vehicle, battery state information, engine state information, and motor state information.

14. The Vehicle-to-Grid system of claim 12, wherein the vehicle surrounding environment information includes weather information.

15. The Vehicle-to-Grid system of claim 11,
wherein the server is configured to determine whether to sell the electricity based on driving condition parameters, and
wherein the driving condition parameters includes at least one of an expected electricity usage amount for a day, a minimum required electricity amount, a required electricity amount margin, a weather-dependent battery usage margin, or a combination thereof in the vehicle.

16. The Vehicle-to-Grid system of claim 11,
wherein the server is configured to determine whether to sell the electricity based on sales feasibility parameters, and
wherein the sales feasibility parameters includes at least one of battery discharging efficiency, battery charging efficiency, discharging efficiency by solar power generation, or a combination thereof.

17. The Vehicle-to-Grid system of claim 16,
wherein the server is configured to determine a profit when selling the electricity based on the sales feasibility parameters, and based on a result of determining the profit, is configured to determine whether to sell the electricity, and
wherein the profit when selling the electricity is determined based on at least one of battery discharging efficiency, battery charging efficiency, solar power generation efficiency, the amount of the electricity available to be sold, or a combination thereof.

18. The Vehicle-to-Grid system of claim 17, wherein the amount of the electricity available to be sold is determined based on an amount of electricity charged in a battery of the vehicle, an expected electricity usage amount for a day, a minimum required electricity amount, a required electricity amount margin, and a weather-dependent battery usage margin.

19. The Vehicle-to-Grid system of claim 17, wherein the server is configured to determine to sell the electricity of the vehicle only when a condition in which a value obtained by subtracting the battery charging efficiency, from a sum of the battery discharging efficiency and the solar power generation efficiency is greater than or equal to a preset threshold value is satisfied.

20. The Vehicle-to-Grid system of claim 14, wherein the weather information is received from a weather information server.
